(19) United States
(12) Patent Application Publication
(10) Pub. No.: US 2011/0317998 A1
(43) Pub. Date: Dec. 29, 2011

(54) DELAY AMOUNT ALLOCATION MEANS, DELAY AMOUNT ALLOCATION METHOD AND A COMPUTER READABLE RECORDING MEDIUM WHICH RECORDS CONTROL PROGRAM OF DELAY AMOUNT ALLOCATION MEANS

(76) Inventor: Atsushi Fujimura, Tokyo (JP)

(21) Appl. No.: 13/148,846

(22) PCT Filed: Mar. 2, 2010
(86) PCT No.: PCT/JP2010/053725

§ 371 Date: Aug. 10, 2011

(30) Foreign Application Priority Data
Mar. 10, 2009 (JP) 2009 056466

(51) Int. Cl. H04B 10/08

(52) U.S. Cl. 398/25

(57) ABSTRACT

In order to calculate an appropriate delay amount of a communication apparatus, delay amount allocating means is provided with round-trip time measurement means which measures a round-trip time which is a difference between a transmission time when a first communication apparatus sends a predetermined signal to each of second communication apparatuses and a reception time when a first communication apparatus receives a response to the predetermined signal, round-trip time comparison means which determines whether a difference between a round-trip time at the present time and a round-trip time in the past time falls within a predetermined range on each of the second communication apparatuses, and a delay amount calculation means which selects a representative value from numerical values between a maximum value and a minimum value of the differences and outputs as a delay amount which is a sum of the representative value and a predetermined value in the case that each of the differences falls within the predetermined range.

### TECHNICAL FIELD

The present invention relates to a star-shaped communication system and a delay amount allocation means, an integrated communication apparatus, a delay amount allocation method, a communication method and computer readable recording medium which records a control program of delay amount allocation means thereof.

### BACKGROUND ART

In a star-shaped communication system, no smaller than one subscriber communication apparatuses are connected with the same station communication apparatus via a branching device. For this reason, in each subscriber communication apparatus is required to specify timing of sending burst datum (hereinafter, referred to as “upstream burst datum”) so as the upstream burst datum from the subscriber communication apparatuses to the station communication apparatus are not collide each other when they are received at the station communication apparatus.

As a practical star-shaped communication system, a PON (Passive Optical Network) system wherein the station communication apparatus connects with the subscriber communication apparatuses via an optical branching device (star-coupler), is available. In the PON system, the subscriber communication apparatus is referred to as ONU (Optical Network Unit). In addition, the line communication apparatus is referred to as OLT (Optical Line Terminal).

Following is a procedure of determining a transmission timing of the upstream burst data in the PON system. The OLT measures transmission delay between the OLT and each of the ONUs. Then, the OLT calculates an equalization delay (hereinafter “EqD”) for each ONU based on the transmission delay. The EqD means a waiting time from receiving a sending data (hereinafter, referred to as “downstream datum”) from the OLT to the ONU to sending the upstream burst datum by the ONU. Then, the OLT allocates obtained EqD to each of the ONU. The upstream burst datum from each ONU is sent to the OLT without collisions by sending the upstream burst datum at the timing based on the EqD of the ONU.

Note that, “ranging” denotes a procedure whereby the OLT measures the transmission delay of the ONU. In addition, “activation” denotes a procedure whereby the EqD is allocated on the ONU by the ranging and establishes a communication of the ONU with the OLT.

Followings are descriptions of a data transmission and a reception timing of the OLT and the ONU by taking the PON system, which is specified by ITU-T (Telecommunication Standardization Sector of ITU) recommendation G.984.3, as an example.

FIG. 5 indicates the transmission and the reception timing of the downstream datum (band allocation information, BW assignment) and the upstream burst datum (Upstream Burst) in the PON system. The OLT sets the transmission timing of the ONU so that it may receive the upstream burst datum from each ONU after TEqD from sending the downstream datum to each ONU. As a result, the OLT can receive the upstream burst datum from each ONU without any collisions.

More specifically, the OLT notifies the ONU of the band allocation information and the EqD. Where, the band allocation information includes a sending start timing (SStart). The SStart is set to the ONU and is a wait time for sending and also a parameter used for the band control of the upstream burst datum.

The ONU waits until sum of the response time of the ONU, the EqD and the SStart is passed since a timing of receiving a datum including the band allocation information and the EqD, then it sends the upstream burst datum. As a result, the upstream burst datum arrives at the OLT further behind the SStart after the TEqD had passed.

FIG. 6 shows the timing of the ranging process. In FIG. 6, the OLT waits for the ranging response from the ONU after sending the ranging request to the ONU until a delayed timing equal to the TEqD. The ONU sends the ranging response to the OLT after passing the response time of the ONU from the ranging request is received. The OLT sets the EqD, which is a difference of the TEqD subtracted by the round-trip time of the data from sending the ranging request to receiving the ranging response, as a value of the concerning ONU. That is, EqD=TEqD−RTD. Then, the OLT notifies the obtained values of the EqD to each of the ONUS. Where, the round-trip time of the data may denote round trip time or RTD (Round Trip Delay). Then, the OLT executes the above mentioned ranging request to all the connected ONU and obtains the EqDs and calculates and allocates the EqD for each ONU.

Further, in the above mentioned descriptions, the definitions including “response time”, a calculation procedure of the EqD and a definition of “SStart” are well-known facts in ITU-T recommendations, and are not directly related to the present invention. Accordingly, detailed descriptions of those definitions will be omitted. An allocation procedure of the delay time by the OLT to the ONU is also basically common in other standardized PON systems such as ITU-T recommendations G.982 and G.983 and IEEE (The Institute of Electrical and Electronics Engineers, Inc.) 802.3ah standard.

In the PON system, it can duplicate the OLT by using 2×N type star-coupler and two OLTs. By duplicating the OLT, it makes a protection switching which can switches to a standby system when a failure occurs on a path between the star-coupler and an active OLT or on the active OLT possible.

In the PON system with the duplicated configuration of the OLT, in the case that a failure occurs on the active OLT, a standby OLT activates the ONUs. After that, the standby OLT changes to the active OLT, and the operation of the PON system will be continued.

However, in the PON system with the duplicated configuration of the OLT, a path length from an ONU to the active OLT may different from a path length from the ONU to the standby OLT. Accordingly, after switching the OLT from the active system to the standby system, the standby OLT needs to allocate the EqD once again to each ONU.

The patent document 1 discloses a configuration where it allocates a delay amount once again in an ONU after the system switching, in the case that it executes an uninterrupted switching of the OLT in the PON system. In the patent document 1, PONIF#1 corresponding to the standby OLT obtains a PD (phase difference) from a received reference phase RO before a system switching and a reception timing U1 from the ONU after the system switching. Then, the PONIF#1 obtains a delay requesting value Td1 from the phase difference PD and notifies the delay amount to the ONU after the system switching.

### DOCUMENTS OF PRIOR ARTS

### Patent Document

Patent document 1: Japanese Patent Application Laid-Open No. 2005-328294

### DISCLOSURE OF THE INVENTION

### Technical Problem

In the PON system with the duplicated configuration of the OLT which is disclosed in the patent document 1, the transmission timing of the ONU may not be optimized after the switching of the OLT. The reason is described with reference to FIG. 7.

FIG. 7 shows the arrival timing of the upstream burst data from the ONUs to the standby OLT in the PON system which is configured with the duplicated configuration of the OLT. FIG. 7 (a) indicates the timing of the upstream burst data which arrive at the active OLT before the switching. FIG. 7 (b) and FIG. 7 (c) indicate a timing of the upstream burst data which arrive at the standby OLT after the switching.

As shown in FIG. 7 (a), before the switching, the upstream burst data are arrived at the active OLT with no collisions. However, after the switching of the OLT, the fluctuation may occur on the timings when ONUs send the upstream datum due to individual difference of each ONU. When this fluctuation is large, the upstream burst data which the ONUs send may collide. FIG. 7 (b) indicates a status that the upstream burst datum from an ONU[3] which is a third ONU collides the upstream burst datum from an ONU[4] which is a fourth ONU.

In order to overcome the status and make the upstream burst data reach the standby OLT without collisions as shown in FIG. 7 (c), it is necessary to allocate an EqD for each of the ONUs. This is because, in the case that the allocated EqD is the same among the entire ONUs, a possibility of collision of the upstream burst data remains, since a relative timing that the ONUs send the burst upstream signals does not change.

However, in PONIF#1 disclosed in the patent document 1, PD which indicates a difference in the timing of the received datum has a constant value before and after the system switching. For this reason, a delay requesting value Td1 which is calculated using PD will also be the same value among the entire ONUs. Accordingly, a phase difference of the datum between the ONUs, namely a gap between the upstream data, is the same as before the switching even after it readjusts the delay requesting value Td1 to the ONUs. Therefore, following to the invention disclosed in the patent document 1, in the case that a fluctuation of the transmission timing of the ONU is large at activations of the ONU, an upstream datum may collide with that of adjacent ONUs.

The object of the present invention is to provide a technology for settling the problem of obtaining an appropriate delay amount of the communication apparatus.

### Technical Solution

The delay amount allocation means of the present invention includes a round-trip time measurement means which measures a round-trip time which is a difference between a transmission time when a first communication apparatus sends a predetermined signal to each of second communication apparatuses and a reception time when the first communication apparatus receives a response to the predetermined signal, a round-trip time comparison means which determines whether a difference between the round-trip time at the present time and the round-trip time in the past time falls within a predetermined range on each of the second communication apparatuses, and a delay amount calculation means which selects a representative value from numerical values between a maximum value and a minimum value of the differences and outputs as a delay amount which is a sum of the representative value and a predetermined value in the cast that each of the differences falls within the predetermined range.

In addition, a delay amount allocation method of the present invention includes a first step which measures a round-trip time which is a difference between a transmission time when a first communication apparatus sends a predetermined signal to each of second communication apparatuses and a reception time when the first communication apparatus receives a response to the predetermined signal, a second step which determines whether a difference between the round-trip time at the present time and the round-trip time in the past time falls within a predetermined range on each of the second communication apparatuses, and a third step which selects a representative value from numerical values between a maximum value and a minimum value of the differences and outputs as a delay amount which is a sum of the representative value and a predetermined value in the case that each of the differences falls within the predetermined range.

Further, a computer readable recording medium, which records a control program of the delay amount allocation means, of the present invention records a program for executing the delay amount allocation means which includes, a round-trip time measurement means which measures a round-trip time which is a difference between a transmission time when a first communication apparatus sends a predetermined signal to each of second communication apparatuses and a reception time when the first communication apparatus receives a response to the predetermined signal, a round-trip time comparison means which determines whether a difference between the round-trip time at the present time and the round-trip time in the past time falls within a predetermined range on each of the second communication apparatuses, and a delay amount calculation means which selects a representative value from numerical values between a maximum value and a minimum value of the differences and outputs as a delay amount which is a sum of the representative value and a predetermined value in the case that each of the differences falls within the predetermined range.

### Effect of the Invention

A delay amount allocation means, an integrated communication apparatus, a delay amount allocation method, a communication method, a computer readable recording medium which stores a control program of delay amount allocation means and a star-shaped communication system according to the present invention makes obtaining an appropriate delay amount of a communication apparatus possible.

### BRIEF DESCRIPTION OF THE DRAWINGS

FIG. 1 is a figure showing a function block of a ranging process unit of a standby OLT in a PON protection system according to the first exemplary embodiment.

FIG. 2 is a figure showing a configuration of the PON protection system.

FIG. 3 is a figure showing the PON protection system and an internal block of an OLT according to the first exemplary embodiment.

FIG. 4 is a flowchart showing an operation of a ranging process unit in the standby OLT after a switching.

FIG. 5 is a figure showing a transmission and reception timing of a downstream datum and an upstream burst datum in the PON system.

FIG. 6 is a figure showing a timing of the ranging process.

FIG. 7 is a figure showing an arrival timing of the upstream burst datum from an ONU to the standby OLT in the PON system with a duplicated configuration of the OLT.

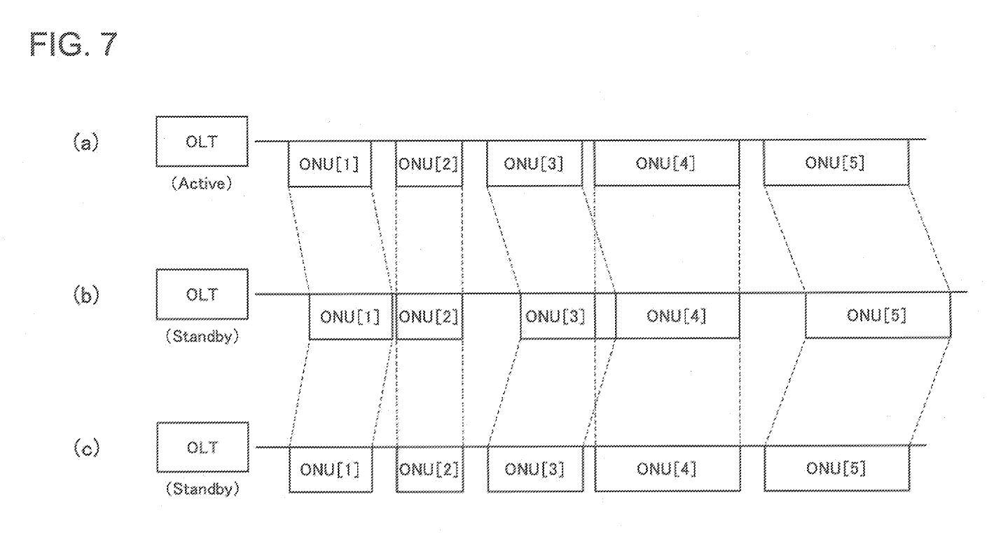

FIG. 8 is a figure showing a configuration when a delay amount allocation means of the present invention is applied to a communication system having a first communication apparatus and a second communication apparatus.

### BEST MODE FOR CARRYING OUT THE INVENTION

### First Exemplary Embodiment

The first exemplary embodiment described below is the delay amount allocation means of the present invention which is applied to the ranging process unit used in a PON protection system.

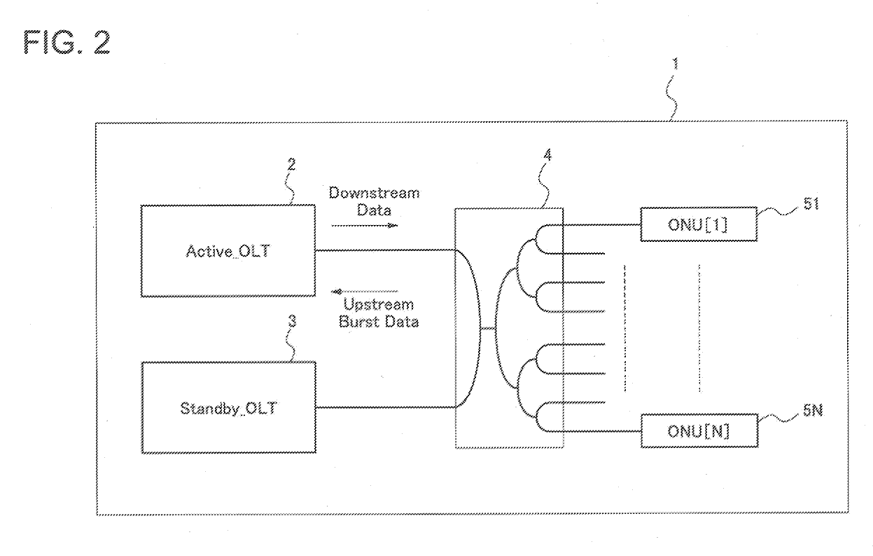

FIG. 2 indicates the configuration of a PON protection system 1.

The PON protection system 1 includes an OLT 2 (active_OLT), an OLT 3 (standby_OLT), a splitter 4 and N number (N is a natural number) of ONUs (ONU 51 to ONU 5N).

The OLT is a station communication apparatus of a communication common carrier. The OLT 2 and the OLT 3 are an active OLT and a standby OLT respectively. The ONU 51 to ONU 5N are subscriber communication apparatuses. These ONUs are installed in subscriber's premises. The splitter 4 is an optical star coupler of type 2×N. The splitter 4 is arranged between the OLT 2 and the OLT 3 and the ONU 51 to ONU 5n. In addition, the splitter 4 branches the downstream datum which is sent from the OLT 2 and the OLT 3 to ONU 51 to ONU 5n, and sends to N number of the ONUs. Further, the splitter 4 multiplexes the upstream burst datum which are sent from the ONU 51 to ONU 5N, and input them to the OLT 2 and the OLT 3. The downstream datum and the upstream burst datum are transmitted after wavelength multiplexing through one core of an optical fiber.

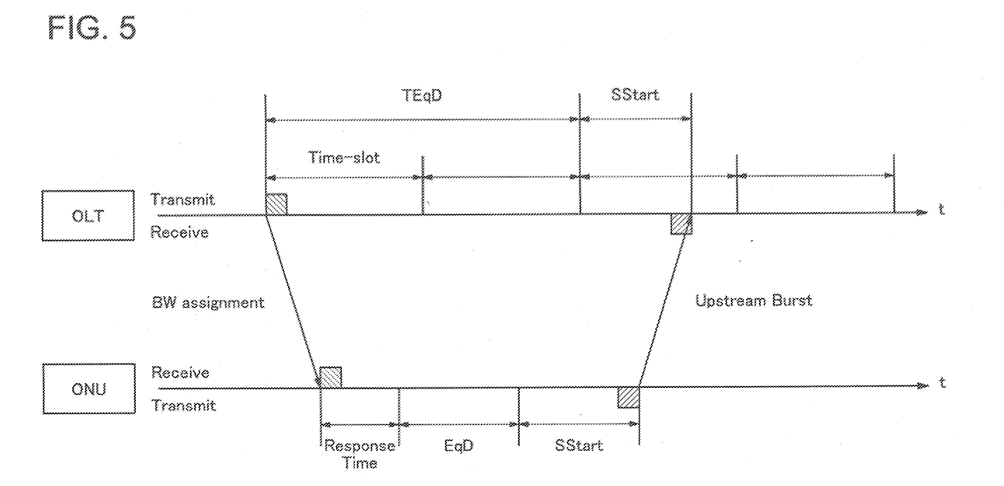

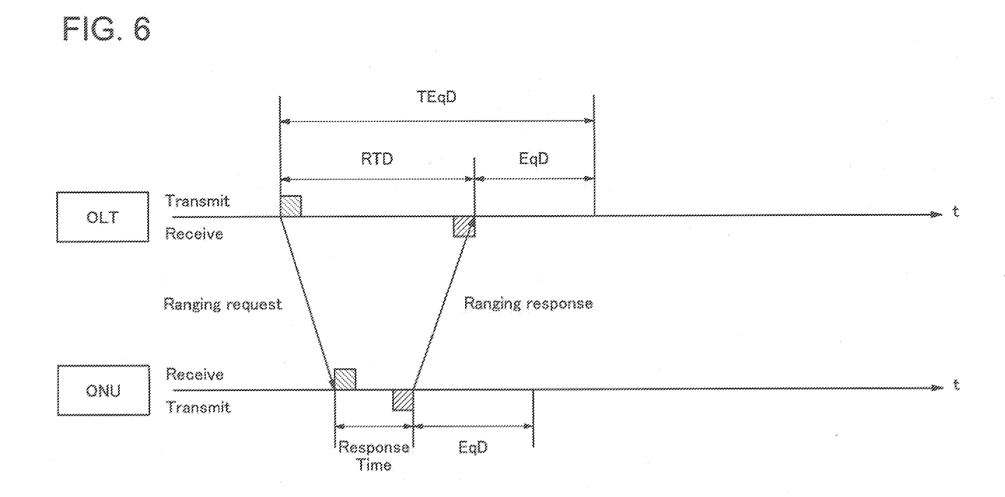

Besides, in the first exemplary embodiment, because the transmission and reception timing of the downstream datum and the upstream burst datum are already described using FIG. 5 and FIG. 6, the descriptions will be omitted.

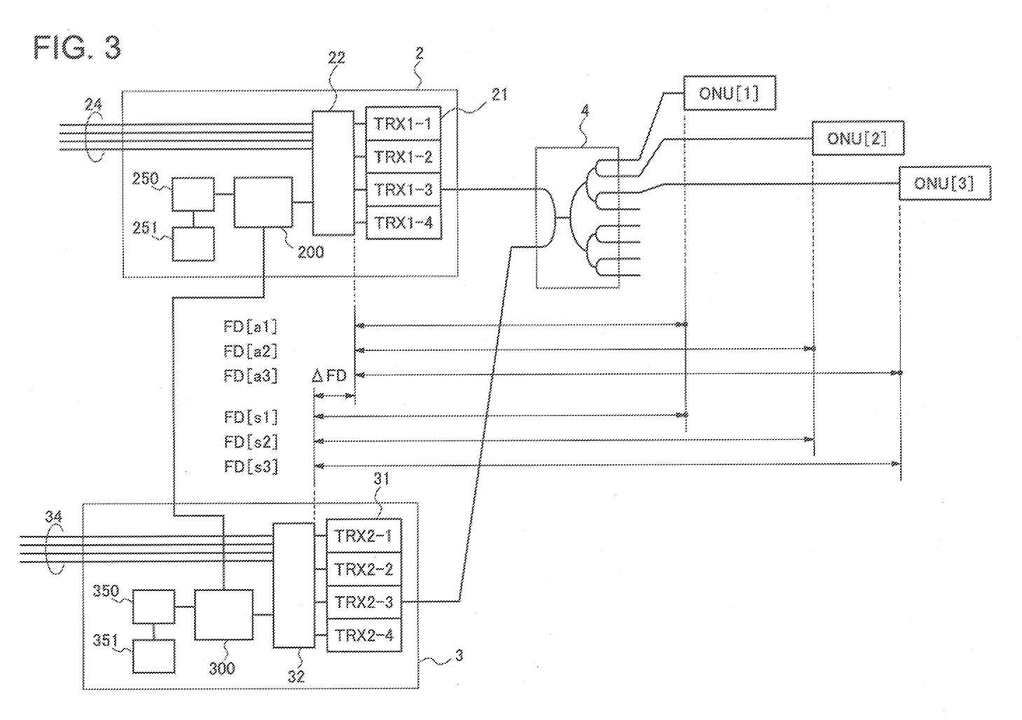

FIG. 3 indicates the PON protection system and the internal block diagram of the OLT according to the first exemplary embodiment.

In FIG. 3, the OLT 2 is the active OLT and the OLT 3 is the standby OLT. The OLT 2 and the OLT 3 include optical transceivers 21 and 31, MAC (Media Access Control) process units 22 and 32, ranging process units 200 and 300, CPUs (central processing unit) 250 and 350 and memories 251 and 351 respectively. In addition, the OLT 2 and the OLT 3 include four optical transceivers respectively. Further, one of the four optical transceivers of each OLT is connected with the splitter 4. Note that, the ranging process units 200 and 300 can be denoted as the delay amount allocation means in general.

The optical transceivers 21 and 31 perform O/E (Optical/Electrical) and E/O (Electrical/Optical) conversions between inside of the OLT and an optical fiber transmission path. The MAC controllers 22 and 32 have interface functions of sending data, which are'inputted from the transmission paths 24 and 34 to the OLT 2 and OLT 3, to the ONUs via the optical transceivers 21 and 31 as the upstream data respectively. In addition, the MAC controllers 22 and 32 also have interface functions of outputting downstream burst data received from the ONUs to the transmission paths 24 and 34 respectively. Further, the MAC controllers 22 and 32 also have functions of sending the EqDs, which the ranging process units 200 and 300 calculated, to the ONUs via the optical transceivers 21 and 31 respectively. The ranging process units 200 and 300 execute the ranging and calculate the EqDs which will be allocated to the ONUs respectively. The CPUs 250 and 350 control the ranging process units 200 and 300 based on programs stored in the memories 251 and 351 respectively.

In FIG. 3, an optical transceiver TRX1-3 of the OLT 2 is connected with a path for the active OLT, and optical transceiver TRX2-3 of the OLT 3 is connected with a path for the standby OLT. Further, three ONUs including ONU[1] to ONU[3] among N ONUs which are connected with both OLTs, are indicated in FIG. 3.

In FIG. 3, a path length on the PON system between the OLT 2 and the ONU[1], the ONU[2] and the ONU[3] are indicated as the FD[a1], the FD[a2] and the FD[a3] respectively. Moreover, the path length between the OLT 3 and the ONU[1], the ONU[2] and the ONU[3] are indicated as the FD[s1], the FD[s2] and the FD[s3] respectively. Further, in FIG. 3, the path length is described where MAC controller, which is a starting point on the OLT side of the PON system, is a starting point. Where, because the difference ΔFD of the path length, which is caused by a switching of the OLT, is the difference of the path length between the splitter and the OLT 2 and the path length between the splitter and the OLT 3, we can get the following equation: ΔFD=|FD[s1]−FD[a1]=|FD[s2]−FD[a2]|=|FD[s3]−FD[a3]|.

### [Description of Operation of the First Exemplary Embodiment]

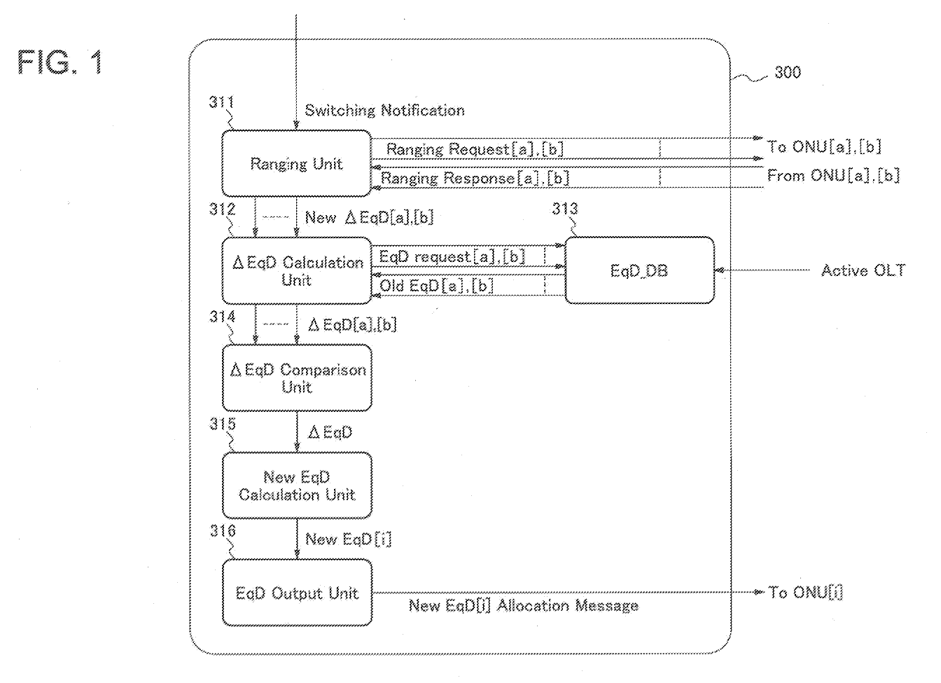

FIG. 1 indicates the function block of the ranging process unit of the standby OLT in the PON protection system according to the first embodiment.

The ranging process unit 300, which is shown in FIG. 1 executes a ranging process so as the standby OLT can communicate with the ONUs after the switching of the OLT. The ranging process unit 300 includes a ranging unit 311, a ΔEqD calculation unit 312, an EqD_DB 313, a ΔEqD comparison unit 314, a new EqD calculation unit and an EqD output unit 316.

When the OLT is switched over from active system to standby system, the ranging unit 311 receives a switching notification from the active OLT. When the ranging unit 311 receives the switching notification, it sends the ranging request to no smaller than one ONUs which are connected with the standby OLT. Although a case that two ONUs including an ONU[a] and an ONU[b] are target objects for the ranging in the following descriptions is described, it can set other quantity of ONUs as the target object for the ranging.

Using the reception timings of the ranging responses received from the ONU[a] and the ONU[b], the ranging unit 311 calculates a new EqD[a] and a new EqD[b], which are the EqDs after the switching. Where, the new EqD[a] and the new EqD[b] are the EqDs corresponding to the ONU[a] and the ONU[b] after the switching respectively.

The ΔEqD calculation unit 312 receives the new EqD[a] and the new EqD[b] from the ranging unit 311. Then, the ΔEqD calculation unit 312 sends directions EqD_request[a] and EqD_request[b], which request replies of the EqDs allocated to the ONU[a] and the ONU[b] just before the switching of the OLT, to the EqD_DB 313.

The EqD_DB 313 is a database which receives and stores the EqD from the active OLT 2 on each ONU just before the protection switching. When the EqD_DB 313 receives the EqD_request[a] and the EqD_request[b] from the ΔEqD calculation unit 312, it returns an old EqD[a] and an old EqD[b], which is the EqD on each ONU just before the protection switching, to the ΔEqD calculation unit 312.

The ΔEqD calculation unit 312 calculates a ΔEqD[a] and a ΔEqD[b] that are differences of the old EqD[a] and the old EqD[b] received from the EqD_DB 313 and the new EqD[a] and the new EqD[b] received from the ranging unit 311 respectively. That is, ΔEqD[a]=new EqD[a]−old EqD[a] and ΔEqD[b]=new EqD[b]−old EqD[b]. Then, the ΔEqD calculation unit 312 notifies the ΔEqD comparison unit 314 of the difference ΔEqD[a] and the difference ΔEqD[b].

The ΔEqD comparison unit 314 judges whether the difference ΔEqD[a] and the difference ΔEqD[b], which are notified from the ΔEqD calculation unit 312, are identical or falling within a predetermined range respectively. Then, the ΔEqD comparison unit 314 notifies the new EqD calculation unit 315 of the determination result and the difference ΔEqD[a] and the difference ΔEqD[b].

The new EqD calculation unit 315 calculates a new EqD[i] (1≦i≦N) for all the ONUs based on the determination result and the ΔEqDs received from the ΔEqD comparison unit 314. A calculation method of the new EqD[i] will be described later.

The EqD output unit 316 sends new EqD allocation message, which allocates a new EqD[i] which the new EqD calculation unit 315 calculated, to the MAC controller.

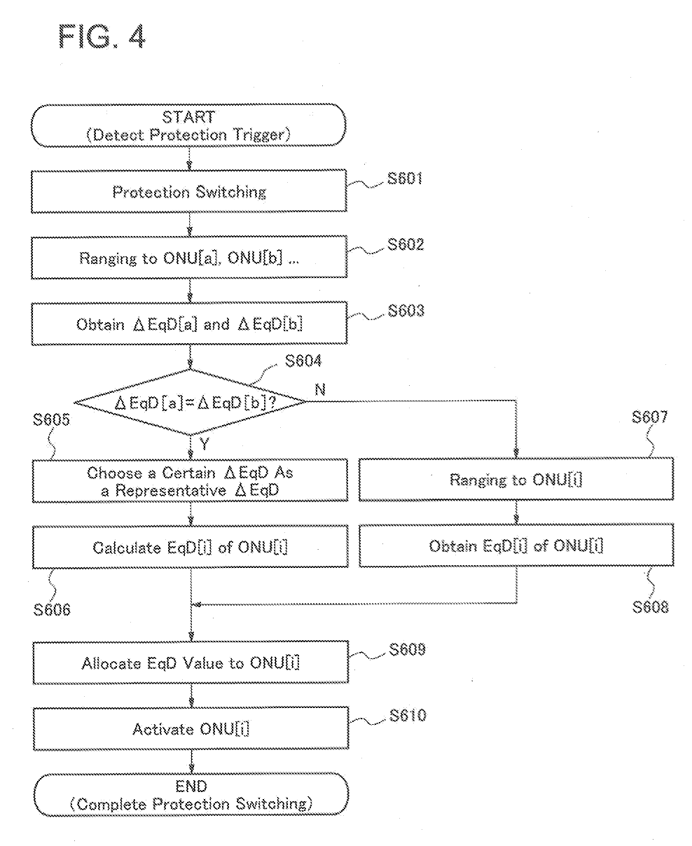

The above mentioned operation of the ranging process unit 3 using a flowchart will be described. FIG. 4 is the flowchart showing the operation of the ranging process unit the standby OLT after the switching.

In FIG. 4, the ranging process is initiated by a detection of a protection trigger inputted to the ranging process unit 3. When the ranging unit 311 detects the protection trigger, the protection switching from the active OLT to the standby OLT is executed (S601).

When the switching of the OLT has been completed, the ranging process unit 3 executes the ranging to no smaller than one ONUs (ONU[a], ONU[b] . . . ) (S602). Then, the ranging process unit 3 calculates a difference ΔEqD between a new EqDs which is obtained after it executed the ranging process in the standby OLT and the old EqD which was allocated by the active OLT to the corresponding ONU before the switching (S603). Here, in the case that the ranging process unit 3 executes the ranging to a plurality of ONUs (ONU[a], ONU[b], . . . ), a plurality of differences ΔEqDs (ΔEqD[a], ΔEqD[b], . . . ) are obtained in accordance with before and after the protection switching.

Then, the ranging process unit 3 checks whether a plurality of the differences ΔEqDs (ΔEqD[a], ΔEqD[b], . . . ) are identical or falling within range of a predetermined value (S604). When all the ΔEqDs are the same or are within range of the predetermined value (S604:Y), a certain ΔEqD is chosen among the ΔEqDs as a representative value (hereinafter, referred to as “representative ΔEqD”) (S605).

Note that, the predetermined range may be set within a range that the upstream burst datum does not collide at any ONU in the case that the new EqD is calculated from the representative ΔEqD which falls within the predetermined range.

Next, the ranging process unit 3 adds representative ΔEqD to the old EqD on each ONU and sets as the new EqD[i] (S606). Because the representative ΔEqD is within a fixed range to the ΔEqD[a] and the ΔEqD[b], the new EqD[i] (1≦i≦N) for N ONUs are also obtained by the procedure. Then, the ranging process unit 3 allocates the new EqD[i] which is obtained in Step S606 to the ONU[i] for the old EqD[i] (S609), and activates the ONU[i] (S610).

Using the procedure, new EqD[i] on all the ONUs can be obtained without executing the ranging to all the ONUs (ONU[l] to ONU[N]). As the result, the number of times of the ranging at a time of the switching of the OLT can be significantly reduced, and high speed protection switching can be executed.

On the other hand, in the case that the differences in a plurality of obtained EqDs are neither identical nor fallen within the predetermined range (N in S604), the ranging process unit 3 executes the ranging process to all the remaining ONU[i] (S607) and calculates a new EqD[i] (S608). Then, the ranging process unit 3 allocates the new EqD[i] to the ONU[i] on behalf of the old EqD[i] (S609) and activates the ONU[i] (S610). In this case, the number of times of the ranging cannot be reduced. However, because the ranging process unit 3 calculates an EqD for each ONU, the ranging process unit 3 can precisely allocate the new EqD to each ONU.

When the new EqD is allocated to the ONUs following to any of the above mentioned flows, the protection switching has been completed. Then, in the PON system, the standby OLT before the switching can be used as the active OLT.

In this way, according to the first exemplary embodiment, the ranging process unit executes the ranging to a part of N number of the ONUs, and calculates a plurality of new EqDs. Then, the ranging process unit selects a certain ΔEqD as the representative ΔEqD, in the case that either each of a plurality of differences ΔEqDs between the new EqDs and the EqDs of the active system are the same, or are within range of the predetermined value. Then, the ranging process unit calculates the new EqDs for the entire ONUs using the representative ΔEqD.

As the result, the ranging process unit can allocate the new EqDs to the entire ONUs without executing the ranging to the entire ONUs. That is, the first exemplary embodiment has an effect that it can reduce an activation time required for the ONUs after the protection switching, by reducing number of times of the ranging process.

Here, the ΔEqD comparison unit checks whether the ΔEqDs falls within the predetermined range to a plurality of ONUs. Therefore, appropriateness of the new EqDs, which is set after the protection switching, is secured by checking the fluctuation of the ΔEqD.

On the other hand, in the case that the fluctuation of the obtained ΔEqDs is large, there will be a possibility that a compensation of the transmission timing on each ONU is not sufficiently executed, in the case that the new EqDs are calculated only from the representative ΔEqD. In this case, as it is indicated in S607 to S608 in FIG. 4, the ranging process unit executes the ranging to all of N ONUs. As the result, according to the first embodiment, it brings an effect that it can set the EqD according to the status of each ONU even when the transmission timing of each ONU fluctuates.

Further, in the above mentioned descriptions, the ranging process unit 3 selects the representative ΔEqD from a plurality of ΔEqDs. However, the ranging process unit 3 may execute the ranging to single ONU. Then, in the case that the obtained single ΔEqD falls within the predetermined range, the ranging process unit 3 may calculate the new EqDs by using the obtained ΔEqD as the representative ΔEqD. In addition, in the case that the obtained single ΔEqD is outside of the predetermined range, the ranging process unit 3 may obtains the ΔEqD for each ONU by executing the ranging to all of N ONUs and obtain the new EqDs from the result.

Note that, as it has been described in FIG. 6, EqD=TEqD−RTD. In general, the TEqD is constant for each PON system. Accordingly, memorizing the RTD (old RTD) of each ONU which is measured by the active OLT in the EqD_DB 313 of the standby OLT, the ranging process unit 3 may obtain the ΔEqD from a difference between the RTD which the standby OLT measured and old RTD.

The target ONU for the ranging should be no smaller than one, and also the target ONU for the ranging can be selected among the ONUs at random. In addition, the number of the ONU for the ranging may be chosen so that the number can be a maximum value during an allowable period for the ranging.

Further, in the case that multiple kinds of the ONU are intermingled in one PON protection system, the fluctuation of the transmission timing may different depending on a kind of the ONU. In this case, it may execute the ranging to at least one of the ONU for each kind of the ONU.

In addition, it may select the representative ΔEqD from a value among a maximum value, a minimum value or a value between the maximum value and the minimum value among a plurality of ΔEqDs. Alternatively, the representative ΔEqD can be decided statistically from a distribution of the ΔEqDs such as from an average value or a median of the ΔEqDs.

Further, selected representative ΔEqD does not need to be single. When a plurality of kinds of ONUs are intermingled in one PON protection system, the ranging process unit may select a plurality of EqDs as the representative ΔEqDs, select a representative ΔEqD for each different kind of ONU and calculate the new EqDs. By doing in this way, the ranging process unit can allocate more suitable new EqD for each kind of ONU.

Further, the EqD_DB 313 may obtain the old EqD just before the switching on each ONU by sending a control instruction to the ONUs and obtains from the ONUs, instead of not from the active OLT 2.

While the above mentioned descriptions concern the ranging process unit which is equipped in the standby OLT, the active OLT may also equip with a similar ranging process unit. In this case, in the case that the switching occurs once again after the active OLT shifted to the standby OLT by the protection switching, the standby OLT (i.e. current active OLT) can execute the similar ranging process.

Further, as a modification of the first embodiment, a configuration can be considered where it executes processes, which will be executed in the ranging unit, the ΔEqD calculation unit and the ΔEqD comparison unit, before the protection switching. Specifically, an ONU for a measuring purpose is installed, a ΔEqD is measured and the value of a new EqD is calculated in advance at a time of optical fiber splice construction of the active OLT side and the standby OLT side of the protection. As the result, the ranging process unit can set a new EqD on each ONU without executing the ranging process after the protection switching will be initiated. Accordingly, further high-speed switching of the protection becomes possible.

As described above, the first exemplary embodiment and the modification thereof brings an effect that it can obtain the appropriate delay amount of the communication apparatus.

### Second Exemplary Embodiment

Next, a second exemplary embodiment of the present invention will be described.

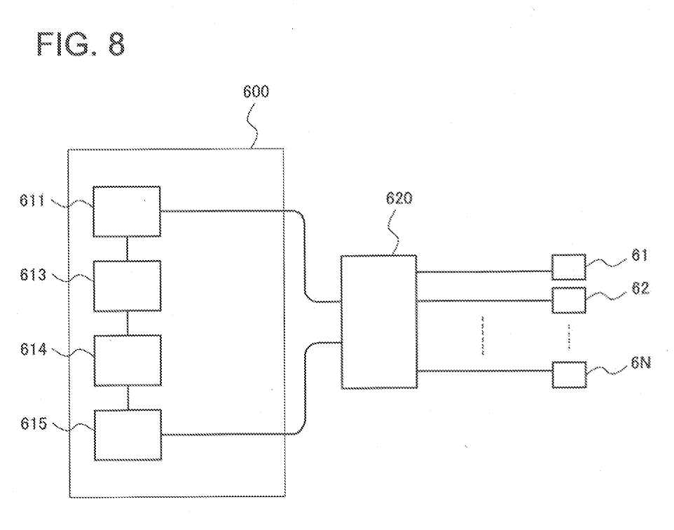

FIG. 8 indicates the configuration where the delay amount allocation means of the present invention is applied to a communication system having a first communication apparatus and second communication apparatuses. In FIG. 8, a delay amount allocation apparatus 600 is connected with the first communication apparatus 620. Second communication apparatuses 61 to 6N are the communication apparatuses which are opposite to the communication apparatus 620.

The delay amount allocation apparatus 600 includes a round-trip time measurement unit 611, a round-trip time comparison unit 613 and a delay amount calculation unit 614. The round-trip time measurement unit 611 measures a round-trip time which is a difference between a transmission time of a predetermined signal which is sent from the first communication apparatus 620 to each of the second communication apparatuses 61 to 6N and a reception time when the first communication apparatus receives responses to the above mentioned predetermined signals. In addition, the round-trip time comparison unit 613 determines whether a difference between the round-trip time at the present time and the round-trip time in the past time falls within a predetermined range on each of the second communication apparatuses. Further, in the case that each of the differences falls within the predetermined range, the delay amount calculation unit 614 selects a representative value from numerical values between a maximum value and a minimum value of the differences, and outputs as a delay amount value that is obtained by adding a second predetermined value to the representative value.

In the second exemplary embodiment, a fluctuation of the round-trip time at the present time to the round-trip time in the past time is calculated by calculating the difference between the round-trip time at the present time and the obtained round-trip time in the past time. Then, the size of the fluctuation of the round-trip time at the present time is judged by whether the difference falls within the predetermined range or not. That is, in the second exemplary embodiment, in the case that the differences of the round-trip time fall within the predetermined range; it selects a representative value from the differences, adds the representative value to the round-trip time in the past time, and calculates the delay amount. As the result, the delay amount allocation apparatus according to the second exemplary embodiment can obtain an appropriate delay amount by which the size of the fluctuation of the round-trip time at the present time is considered.

Further, the exemplary embodiment of the present invention described above does not aim for applying to a specific star-shaped communication system. The present invention can be applied to any PON systems which is compliant with standardized recommendations and standards such as ITU-T recommendations G.982, G.983 and G.984 and IEEE (The Institute of Electrical and Electronics Engineers, Inc.) 802.3ah standard. Moreover, the present invention can also be applied to a star-shaped communication system in addition to the PON system.

While having described the invention of the present application referring to the exemplary embodiments, the invention of the present application is not limited to the above mentioned exemplary embodiments. It is to be understood that to the configurations and details of the invention of the present application, various changes can be made within the scope of the invention of the present application by those skilled in the arts.

This application claims priority from Japanese Patent Application No. 2009-056466, filed on Mar. 10, 2009, the disclosure of which is incorporated herein in its entirety by reference.

### DESCRIPTION OF THE REFERENCE SIGNS

1 PON protection system
2 and 3 OLT
4 splitter
21 and 31 optical transceiver
22 and 32 MAC controller
24 and 34 input/output transmission path
51 to 5N ONU
61 to 6N communication apparatus
200 and 300 ranging process unit
250 and 350 CPU
251 and 351 memory
311 ranging process unit
312 ΔEqD calculation unit
313 EqD_DB
314 ΔEqD comparison unit
315 new EqD calculation unit
316 EqD output unit
600 delay amount allocation apparatus
611 round-trip time measurement unit
613 round-trip time comparison unit
614 delay amount calculation unit
615 delay amount output unit
620 communication apparatus

1. A delay amount allocation unit, comprising:
a round-trip time measurement unit which measures a round-trip time which is a difference between a transmission time when a first communication apparatus sends a predetermined signal to each of second communication apparatuses and a reception time when said first communication apparatus receives a response to said predetermined signal;
a round-trip time comparison unit which determines whether a difference between said round-trip time at the present time and said round-trip time in the past time falls within a predetermined range on each of said second communication apparatuses; and
a delay amount calculation unit which selects a representative value from numerical values between a maximum value and a minimum value of said differences and outputs as a delay amount which is a sum of said representative value and a predetermined value in the case that each of said differences falls within the predetermined range.

2. The delay amount allocation unit according to claim 1, wherein
the measurement of said round-trip time is executed to a part of said second communication apparatuses.

3. The delay amount allocation unit according to claim 1, wherein
said delay amount calculation unit outputs a sum of said predetermined value and each of said differences in the case that said differences are not fallen within the predetermined range.

4. The delay amount allocation unit according to claim 1, wherein
said predetermined value is said round-trip time in the past time.

5. The delay amount allocation unit according to claim 1, wherein
said delay amount allocation unit is used in a PON (Passive Optical Network) system, wherein
said first communication apparatus and said second communication apparatus are connected via a star-coupler; and
said second communication apparatus sends data to said first communication apparatus based on the delay amount which is allocated by said first communication apparatus.

6. An integrated communication apparatus, comprising:
the delay amount allocation unit according to claim 1; and
a transmission and reception unit which sends and receives signals to and from destinations.

7. The integrated communication apparatus according to claim 6, wherein
said round-trip time in the past time is said round-trip time which other said first communication apparatuses have measured.

8. The integrated communication apparatus according to claim 7, wherein
said round-trip time comparison unit initiates measuring of said response time at the present time at a beginning of switching from other said first communication apparatuses to said first communication apparatus.

9. A delay amount allocation method, comprising:
measuring a round-trip time which is a difference between a transmission time when a first communication apparatus sends a predetermined signal to each of second communication apparatuses and a reception time when said first communication apparatus receives a response to said predetermined signal;
determining whether a difference between said round-trip time at the present time and said round-trip time in the past time falls within a predetermined range on each of said second communication apparatuses; and
selecting a representative value from numerical values between a maximum value and a minimum value of said differences and outputting as a delay amount which is a sum of said representative value and a predetermined value in the case that each of said differences falls within the predetermined range.

10. The delay amount allocation method according to claim 9, wherein
said measuring is executed to a part of said second communication apparatuses.

11. The delay amount allocation method according to claim 9, further comprising:
outputting a sum of each of said differences and said predetermined value in the case that said differences are not fallen within the predetermined range.

12. The delay amount allocation method according to claim 9, wherein
said predetermined value is said round-trip time in the past time.

13. The delay amount allocation method according to claim 9, wherein
said delay amount allocation method is used in a PON system, wherein
said first communication apparatus and said second communication apparatus are connected via a star-coupler; and
said second communication apparatus sends data to said first communication apparatus based on the delay amount which is allocated by said first communication apparatus.

14. A communication method in the delay amount allocation method according to claim 9, further comprising:
sending and receiving signals to and from destinations.

15. A computer readable recording medium which records a control program of a delay amount allocation unit, said program causing said delay amount allocation unit to perform as an unit, said unit comprising:
a round-trip time measurement unit which measures a round-trip time which is a difference between a transmission time when a first communication apparatus sends a predetermined signal to each of second communication apparatuses and a reception time when said first communication apparatus receives a response to said predetermined signal;
a round-trip time comparison unit which determines whether a difference between said round-trip time at the present time and said round-trip time in the past time falls within a predetermined range on each of said second communication apparatuses; and
a delay amount calculation unit which selects a representative value from numerical values between a maximum value and a minimum value of said differences and outputs as a delay amount which is a sum of a predetermined value and said representative value in the case that each of said differences falls within the predetermined range.

16. The computer readable recording medium which records the control program of the delay amount allocation unit according to claim 15, wherein
said recording medium is used in PON system, wherein
said first communication apparatus and said second communication apparatus are connected via a star-coupler, and
said second communication apparatus sends data to said first communication apparatus based on the delay amount which is allocated by said first communication apparatus.

17. A star-shaped communication system where second communication apparatuses are connected to the same first communication apparatus via a branching device, wherein
said first communication apparatus is the integrated communication apparatus according to claim 6.

18. The star-shaped communication system according to claim 17, wherein
said branching device is a star-coupler, and said star-shaped communication system is the PON system.
